(19) United States
(12) Patent Application Publication
(10) Pub. No.: US 2011/0282719 A1
(43) Pub. Date: Nov. 17, 2011

(54) PROMOTIONAL MARKETING VIA BAGGAGE TAGGING

(75) Inventor: Cyril Turner, Atlanta, GA (US)

(73) Assignee: DAL Global Services, LLC, Atlanta, GA (US)

(21) Appl. No.: 13/105,631

(22) Filed: May 11, 2011

Related U.S. Application Data
(60) Provisional application No. 61/333,920, filed on May 12, 2010.

(51) Int. Cl. G06Q 30/00

(52) U.S. Cl. 705/14.1; 705/14.66; 705/14.5

(57) ABSTRACT

Systems and methods for distributing marketing materials to airline consumers are disclosed. A promotion management system receives information regarding an airline consumer's checked baggage. The promotion management system has a processor and databases holding such information as client profiles, destination information, and vendor promotions. The processor determines which vendor promotion is mostly likely to be of interest to the airline consumer, and then transmits the selected vendor promotion to a remote device that provides the marketing material. This marketing material, which may be a coupon or a promotional offer, is then attached to the baggage of the airline consumer. The baggage and the attached marketing material are processed and transported to the arrival baggage claim. The airline consumer retrieves the baggage, reviews the marketing material, and may then choose to respond to the marketing material.

### RELATED APPLICATIONS

This application relates to, claims priority from, and incorporates herein by reference, as if fully set forth, U.S. Provisional Patent Application Ser. No. 61/333,920 filed on May 12, 2010 and titled “COUPON PROMOTION VIA LUGGAGE TAGGING.”

### BACKGROUND OF THE INVENTION

1. Field of the Invention

The present invention relates in general to promotional marketing methods and systems. More particularly, the invention is directed to methods and systems for distributing promotional offers to business and leisure travelers such as airline consumers by attaching marketing materials to travelers' baggage.

2. Description of the Related Art

Business and leisure travelers such as airline consumers are an important target market for marketers as these consumers typically have higher-than-average incomes. Current efforts to market to this important market segment have been costly and generally ineffective. For example, traditional marketing approaches such as mailing promotional offers to an airline's frequent flier clients face high postage costs and low redemption rates.

Accordingly, a need exists to improve marketing to business and leisure travelers.

### SUMMARY OF THE INVENTION

In a first aspect, a computer-implemented method of distributing promotional offers to airline consumers is provided. The method includes receiving routing tag information by a processor from an airline computer system, where the routing tag information is associated with an airline consumer's checked baggage and selecting a marketing material by the processor based on the routing tag information. The method further includes providing the selected marketing material from a device in communication with the processor, where the marketing material is configured for attaching to the baggage, attaching the marketing material to the baggage, and returning the baggage with attached marketing material to an airline consumer.

In a first preferred embodiment of the method, the marketing material comprises a discount for new luggage. The marketing material has a coupon for a company's product or service. The coupon preferably has a unique offer code. The method preferably further includes receiving coupon redemption information by the processor indicating that the airline consumer has redeemed the coupon. The method preferably includes generating a promotional fee request from a promoter to a vendor associated with the redeemed coupon.

The method preferably selects the marketing material based on an arrival time of the airline consumer's flight. The marketing material is selected based a profile of the airline consumer. The marketing material is preferably selected based on a weather forecast for the destination at the estimated time of arrival of the airline consumer.

In a second aspect, a computer-implemented method includes maintaining a database in communication with a processor for storing information related to selecting a marketing material, and receiving routing tag information by the processor from an airline computer system, where the routing tag information is associated with an airline consumer's checked baggage. The method further includes selecting a marketing material by the processor based on the routing tag information and the information stored in the database, and providing the selected marketing material from a device in communication with the processor, where the marketing material is configured for attaching to the baggage. The method further includes attaching the marketing material to the baggage, and returning the baggage and the attached marketing material to the airline consumer.

In a second preferred embodiment, the routing tag information further includes an identity of an airline consumer and a destination of the airline consumer. The database further has a client profiles database for storing a client profile associated with the airline consumer. The method further includes selecting the marketing material based on the identity of the airline consumer and the client profile associated with the airline consumer.

The database preferably further includes a destination information database for storing information on airline destinations. The method preferably further includes selecting the marketing material based on the destination of the airline consumer and the destination information database.

The database preferably includes a vendor promotions database. The method preferably further includes selecting the marketing material based on the identity of the airline consumer, the client profile associated with the airline consumer, the client profiles database, and the vendor promotions database. The device providing the marketing material is located at an airline consumer's departing airport. The device providing the marketing material is preferably located at an airline's hub airport. The device providing the marketing material is preferably located at an airline's destination airport.

In a third aspect, a system for distributing promotional offers to airline consumers is provided. The system has an airline computer system configured for providing routing tag information for an airline consumer's checked baggage, and a promotion management system having a database coupled to a processor configured for selecting a marketing material based on the routing tag information. The system also has a device for providing a marketing material where the marketing material is configured for attaching to the checked baggage.

In a third preferred embodiment, the routing tag information further comprises an identity of an airline consumer and a destination of the airline consumer. The database preferably has a client profiles database for storing information about the airline consumer. The processor is preferably further configured for selecting marketing material based on the identity of the airline consumer and a client profile associated with the airline consumer.

The database preferably has a destination information database for storing information on the airline destinations and a processor that is further configured for selecting the marketing material based on the destination of the airline consumer and the destination information database.

The database preferably further has a vendor promotions database; and the processor is further configured for selecting the marketing material based on the identity of the airline consumer, the client profile associated with the airline consumer, the client profiles database, and the vendor promotions database. The device providing the marketing material is preferably located at an airline's hub airport.

These and other features and advantages of the invention will become more apparent with a description of preferred embodiments in reference to the associated drawings.

### DESCRIPTION OF THE DRAWINGS

FIG. 1 is a schematic illustration of an exemplary embodiment.

FIG. 2A is a flow chart illustrating exemplary actions for an airline consumer receiving marketing material attached to their baggage.

FIG. 2B is a flow chart illustrating exemplary actions for an airline employing non-targeted marketing.

FIG. 2C is a flow chart illustrating exemplary actions for an airline employing targeted market where the marketing material is attached during check-in

FIG. 2D is a flow chart illustrating exemplary actions for an airline employing targeted marketing where the marketing material is attached to the baggage during transit.

FIG. 2E is a flow chart illustrating exemplary actions for a promoter.

FIGS. 3A-3G are illustrations of exemplary marketing materials.

FIG. 4A is a schematic illustration of an exemplary system employing a promotion management system within the airline system.

FIG. 4B is a schematic illustration of another exemplary system employing a promotion management system connected via a network to an airline system.

FIG. 5 is a schematic illustration of an exemplary promoter management system.

FIG. 6 is a schematic illustration of a preferred system employing a promotion management system coupled to an airline computer system.

FIGS. 7A and 7B are flow charts illustrating exemplary processes for distributing marketing material to airline consumers.

### DETAILED DESCRIPTION OF THE PREFERRED EMBODIMENTS

The following preferred embodiments are directed to systems and methods for distributing marketing materials to business and leisure travelers such as airline consumers. Such systems and methods may be incorporated into existing airline computer and network systems. A promotion management system receives information regarding an airline consumer's checked baggage. The promotion management system has a processor and databases holding such information as client profiles, destination information, and vendor promotions. The processor determines which vendor promotion is mostly likely to be of interest to the airline consumer, and then transmits the selected vendor promotion to a remote device that provides the marketing material. This marketing material, which may be a coupon or a promotional offer, is then attached to the baggage of the airline consumer. The baggage and the attached marketing material are processed and transported to the arrival baggage claim. The airline consumer retrieves the baggage, reviews the marketing material, and may then choose to respond to the marketing material.

One or more embodiments are directed to systems and methods for distributing marketing materials to airline consumers. However, the description is not intended to limit the embodiments to the form disclosed herein, and is not intended to limit the embodiments to distributing marketing materials only to airline consumers. System and methods directed to distributing marketing materials to other leisure and business travelers such as persons traveling via cruise ships, trains, interstate and intrastate buses, and other forms of transportation are contemplated in one or more embodiments.

This method offers a unique means to market to airline consumers. Airline consumers, particularly business travelers, represent a highly desirable target market for marketers. The average income for airline consumers is typically greater than that found in other market segments. In fact, some studies suggest that a sizable portion of airline consumers have annual incomes in excess of $100,000. However, reaching this important market segment using traditional marketing approaches has been largely ineffective.

The method of attaching marketing material on baggage is a new marketing medium that requires airline consumers to interact with the marketing material. At the very least, an airline consumer would read the marketing material and then decide whether to discard the marketing material or redeem an offer. This method may also prompt impulse buying for items that an airline consumer may not have otherwise considered. Regardless of the airline consumer's response to the marketing material, the marketing material creates awareness of a promotional offering more effectively than that other promotional means such as that through print, radio, television, online, and billboard advertising.

Airline consumers may also be individually targeted because they are naturally members of market segments who are attracted to particular goods or services. In general, target marketing partitions the overall market of airline consumers into smaller market segments which enables marketers to direct marketing resources efficiently toward those airline consumers who are more likely to be interested in particular goods or services. Target marketing assumes that market segments can be identified based on the airline consumers' profiles, demographics, purchasing history, current travel destination, and other factors. For example, an airline consumer traveling to Orlando with children leaving on a weekend would likely be more interested in a coupon for a theme park than would an airline consumer traveling alone leaving on a Monday morning.

Furthermore, certain industries offer goods and services such as luggage, theme parks and other venues, rental cars, hotels, and noise cancelling headphones that would target airline consumers. Many of the “near use opportunities” such as rental cars and hotels would benefit from this method as the airline consumer receives an offer at the optimal time and place. This method may also be implemented as a means for an airline consumer to recover the baggage fees frequently charged by airlines. For example, an airline consumer may recover their baggage fee by purchasing new luggage.

The method of attaching marketing materials to baggage is also potentially more cost-effective than traditional means for marketing. For example, current costs for direct mail advertising may exceed $0.52 per card taking into account printing, handling, postage, and waste associated with outdated and incorrect mailing lists. Marketing employing direct mailing also tends to have relatively low redemption rates. The projected costs for attaching marketing material on baggage may be 10% to 30% less than the direct mailing costs. The redemption rates for marketing material attached to baggage promises to be higher than that of traditional methods. This method is also less wasteful than traditional direct mailing because one side of the post card requires postage and address and therefore has no marketing value. In contrast, both sides of a marketing material can be used to double the ad impression. Likewise, two advertisers could share a marketing material each having one side to offer a promotion or discount.

This method could potentially be employed by manufacturers to attract consumers directly to the manufacturer's website and bypass the traditional retail chain. Manufacturers could therefore forego retail markups and could, consequently, charge lower prices. This method could also be employed to direct traffic to a physical store or to encourage an airline consumer to send a text message. For example, a not-for-profit organization may consider implementing a fundraising campaign where passengers can send text messages on their mobile phones to make a contribution.

This method may also enable new performance models for rewarding agents, advertisers, and frontline employees. The use of unique tracking identifiers on marketing materials provide a means for paying based on redemptions. This method is in contrast with traditional advertising where the advertisement is paid upfront and the effectiveness of the advertisement is unknown. This model may also be implemented by charging a flat fee for distribution. Alternatively, the use of unique codes employed in the redemption model could instead be used for sampling purposes. More specifically, if a particular agent is associated with one of the unique numbers on one of the cards, and that card is subsequently identified or sampled at the destination airport, that agent would receive more pay. This would create an incentive for the agent to tag even more bags and thereby insuring broader distribution of the promotional materials.

The marketing materials may attach in several methods and comprise different forms. For example, the marketing materials may attach to the baggage through the use of an elastic string secured to the handles of the baggage. The use of an elastic string requires the airline consumer to have greater interaction with the marketing material. Alternatively, the marketing materials may have an adhesive surface to enable the marketing materials to attach to the surface of baggage. The marketing material may be in the form of a promotional message that is part of the routing tag. However, this approach may increase the costs as promotional messages would typically require color print which may increase the overall costs. Another potential implementation of this approach would print promotional messages on the airline consumer's boarding pass. The marketing materials may be attached during check-in, during transit at an airline hub for example, or at the destination airport.

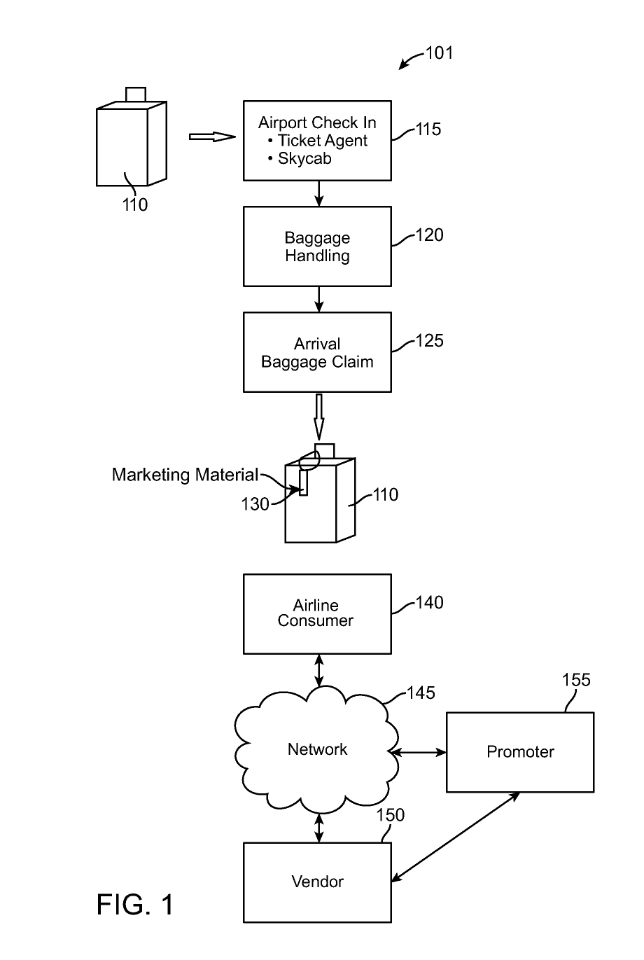

FIG. 1 is a schematic illustration of an exemplary embodiment 101. An airline consumer's checked baggage is received by the Airport Check-in (step 115). The airline check-in may be performed by a ticketing agent, an automated ticketing and baggage check in station, or by the Skycab. The checked baggage is then labeled, processed, and transported (step 120) to the airline consumer's arriving baggage claim (step 125). The airline consumer retrieves the checked baggage 110 and finds a marketing material 130 attached to the baggage. The marketing material 130 may have been attached to the checked baggage 110 during airport check in (step 115), during baggage handling (step 120), or upon arrival to the baggage claim (step 125).

Depending on the type of marketing material 130, the airline consumer 140 may interact with either a promoter 155 or a vendor 150 through a network 145. If the marketing material 130 is a coupon for discount prices on new luggage, for example, the airline consumer may place and pay for an order with the promoter 155. The promoter 155 may then contact the vendor 150 to instruct the vendor to send the ordered items to the airline consumer 140 and forward the payment, less promotional fees, to the vendor 150. The promoter 155 would receive a promotion fee for facilitating the transaction.

In another example, the marketing material may comprise an offer to enter into a sweepstakes. The airline consumer may then contact the promoter 155 with the offer information. The promoter 155 then accumulates information from the airline consumer 140 and provides it to the vendor 150 for a promotion fee.

These non-limiting examples are for illustration purposes only. Any related types of interactions and/or communications between the airline consumer 140, the promoter 155, and the vendor 150 is in accordance with the spirit of these embodiments.

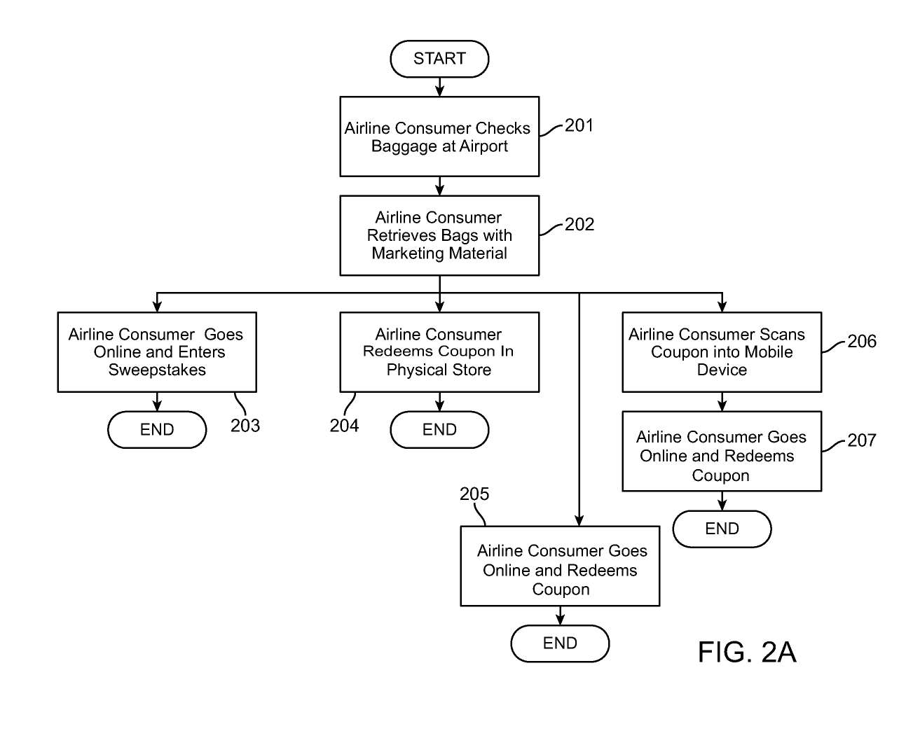

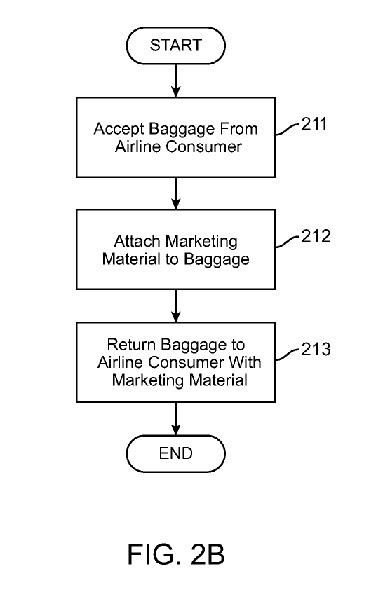

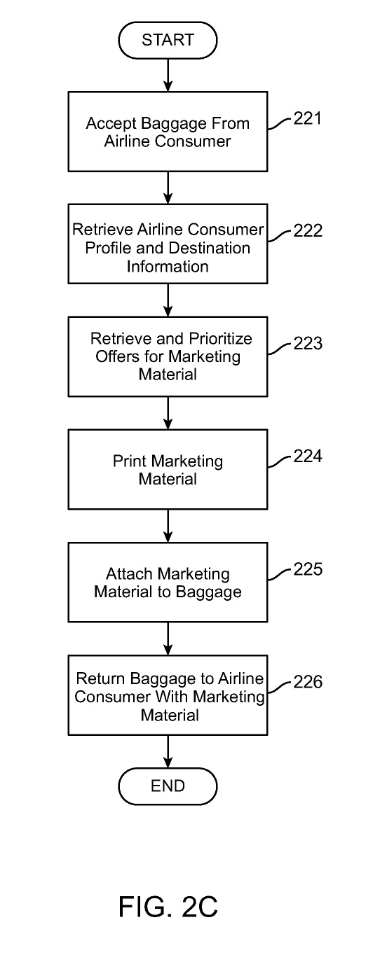

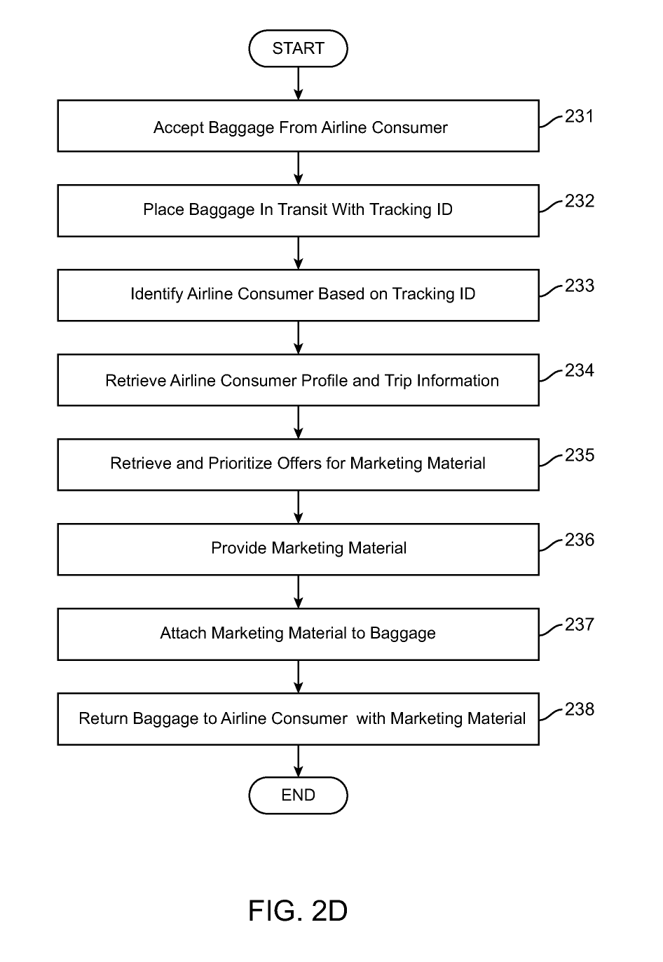

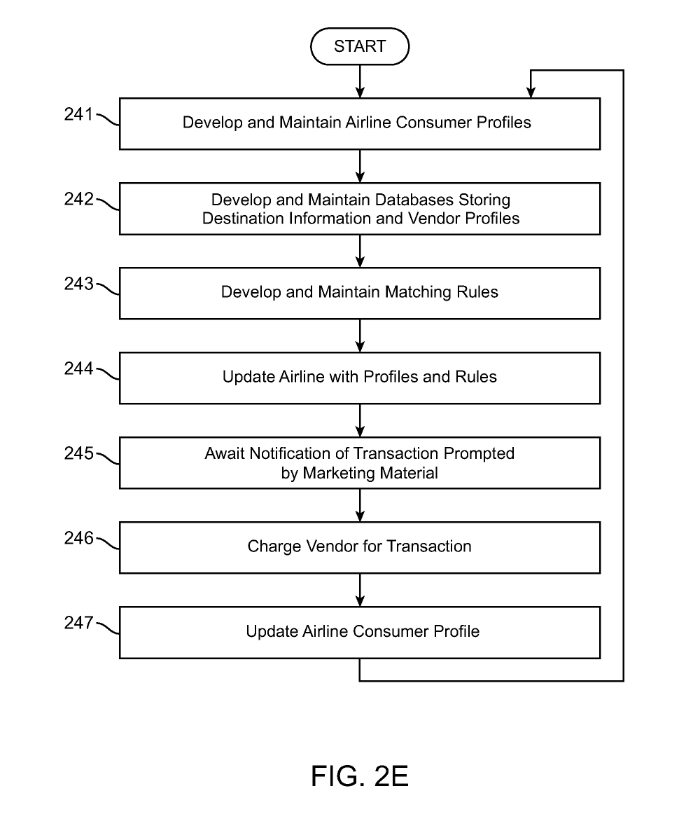

FIG. 2A is a flow chart illustrating exemplary actions from the perspective of an airline consumer receiving marketing material attached to their baggage. The airline consumer 140 checks the baggage 110 at the airport (step 201). The airline consumer 140 then retrieves the baggage at the destination baggage claim and finds the checked baggage 110 with a marketing material 130 attached to the checked baggage (step 202). In one non-limiting scenario, the marketing material 130 may be an offer to participate in a sweepstakes requiring the airline consumer 140 to go online and enter a sweepstakes (step 203). In another non-limiting scenario, the marketing material 130 may be in the form of a coupon offering discounted pricing on goods such as new luggage, for example. Here, the airline consumer 140 redeems the coupon in a physical store (step 204). In another non-limiting scenario, the marketing material 130 may be an electronic coupon offering a code to purchase items online at a discounted price. The airline consumer goes online and redeems the coupon electronically (step 205). In another non-limiting scenario, the marketing material 130 may have a coupon such as a bar code that the airline consumer can scan into a mobile device such as a smart phone (step 206). The airline consumer then goes online with the mobile device and redeems the coupon electronically (step 207).

FIG. 2B is a flow chart illustrating exemplary actions from the perspective of an airline employing non-targeted marketing. Non-targeted marketing may refer to applying the same marketing materials and efforts to all airline consumers or all airline consumers traveling on the same flight for example. The airline accepts the checked baggage 110 from the airline consumer 140 (step 211). As the checked baggage 110 is processed, transported, and received, a marketing material 130 is placed on the checked baggage 110 (step 212). The airline returns the checked baggage 110 with the attached marketing material 130 to the airline consumer 140 (step 213).

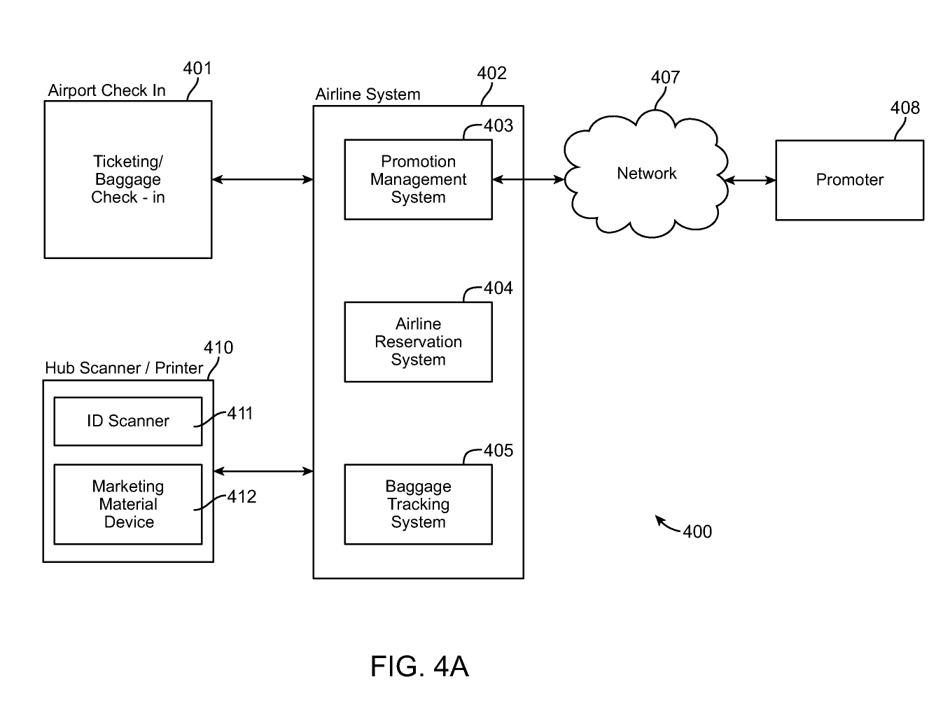

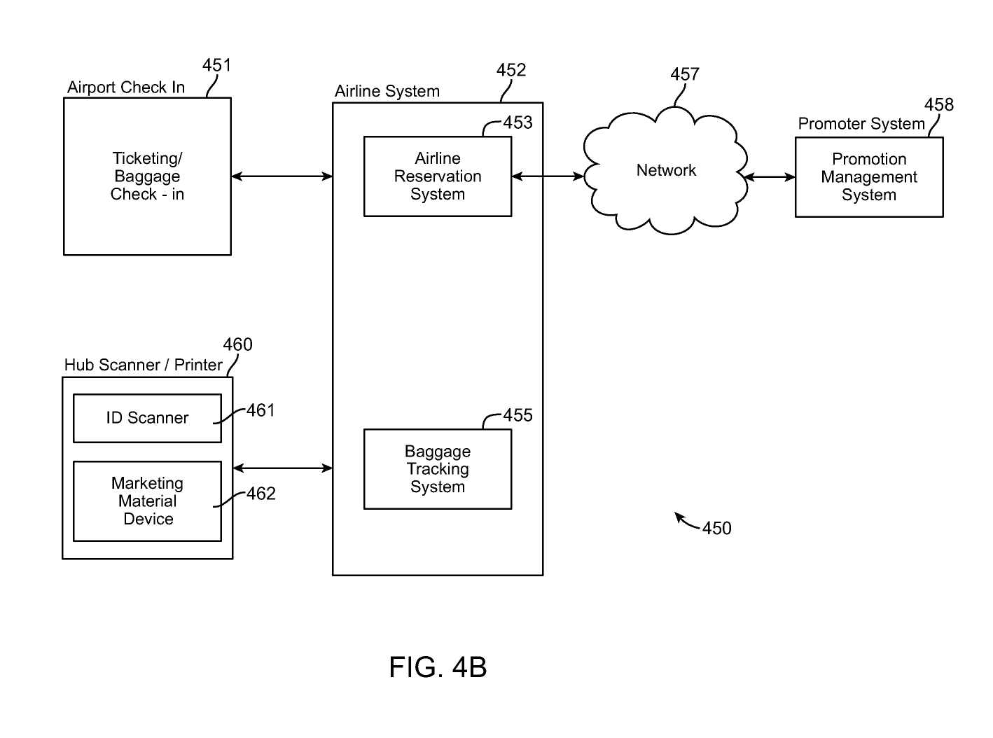

FIGS. 2C and 2D illustrate exemplary actions of the airline when the airline consumers are individually target marketed. FIGS. 4A and 4B present schematic illustrations of exemplary systems employing a promotion management system utilizing target marketing within an airline system. Both systems employ traditional airport check-in terminals (401 or 451), and an airline system (402 or 452). FIG. 4A illustrates an exemplary system 400 in which the promotion management system 403 is integrated into the airline system 402. FIG. 4B illustrates an exemplary system 450 in which the promotion management system is coupled to the airline system 452 through a network 457. Both systems illustrate a hub scanner and printer (410 or 460) which may be employed when the checked baggage 110 is tagged with the marketing material 130 at an airline hub. The ID scanner (411 or 461) scans the routing tag on the checked baggage 110, sends the routing tag information to the promotion management system 403 or 458) for processing. The marketing material device (412 or 462) then provides the marketing material 130 to be attached to the checked baggage 110. This marketing material device may be a printer or a “ticket-dispenser” apparatus that provides pre-printed coupons or promotional materials for example.

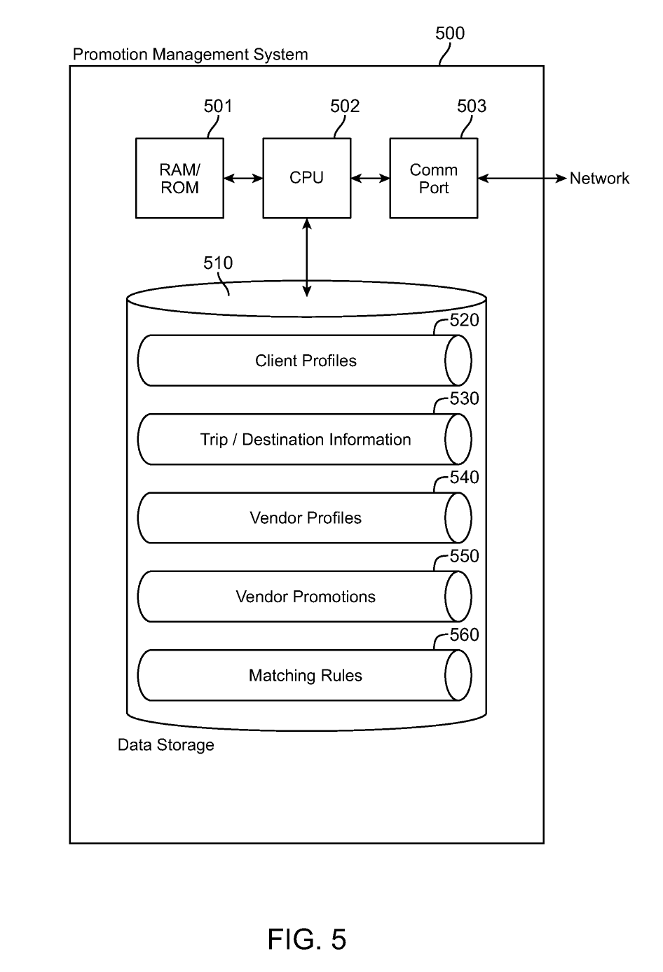

Details of a promoter management system 500 may be found in FIG. 5. The promoter management system 500 has a processor 502 which is coupled to RAM/ROM memory 501 and a communication port 503. The processor 502 is also coupled to a database 510 which holds a client profiles database 520, a trip/destination information database 530, vendor profiles database 540, vendor promotions database 550, and matching rules database 560. Processor 502 may be implemented using a single computer processing unit or may be implemented with multiple computer processing units.

FIG. 2C is a flow chart illustrating exemplary actions from the perspective of an airline employing targeted marketing where the marketing material 130 is attached to the checked baggage 110 at check-in. In this scenario, the airline identifies the airline consumer 140 and accepts the checked baggage 110 at the airline check-in terminal 401 or 451 (step 221). The promotion management system (403 or 458) receives the identity of the airline consumer 140 and retrieves the client profile of the airline consumer 140 and information of the airline consumer's final destination (step 222). The promotion management system (403 or 458) retrieves and prioritizes the offer for the marketing material 130 (step 223). The promotion management system (403 or 458) transmits information for the selected marketing material to the Marketing Material Printer (412 or 462) which prints the marketing material 130 (step 224). The marketing material 130 is attached to the checked baggage 110 (step 225). The marketing material 130 may be attached to the checked baggage 110 at the departing airport, the arriving airport, the airline's hub airport, or anywhere along the transportation route of the checked baggage 110. The airline returns the checked baggage 110 with the attached marketing material 130 to the airline consumer 140 (step 226).

The identity of the airline consumer 140 may be retrieved from information placed on the routing tag which typically includes the name of the airport of departure, the departure time, the airport code of the airport of arrival, the airline code and flight number, and the first and last name of the passenger.

FIG. 2D is a flow chart illustrating exemplary actions for an airline employing targeted marketing where the marketing material is attached to the baggage during transit such as at an airline hub. Referring again to FIGS. 4A and 4B in this scenario, the airline identifies the airline consumer 140 and accepts the checked baggage 110 at the airline check-in terminal (401 or 451) at step 231. The baggage is tagged with a tracking ID and placed in transit to the airline consumer's final destination (step 232). At some point during transit, the identity of the airline consumer 140 is obtained based on the baggage tracking ID and is sent to the promotion management system (403 or 458) at step 233. The promotion management system (403 or 458) retrieves the client profile of the airline consumer 140 and information of the airline consumer's final destination (step 234). The promotion management system (403 or 458) retrieves and prioritizes the offers for the marketing material 130 (step 235). The promotion management system (403 or 458) transmits information for the selected marketing material to Marketing Material Device (412 or 462) which provides the marketing material 130 (step 236). The marketing material 130 is attached to the checked baggage 110 (step 237). The airline returns the checked baggage 110 with the attached marketing material 130 to the airline consumer 140 (step 238).

FIG. 2E is a flow chart illustrating exemplary actions for a promoter. The promoter develops and maintains client profiles in the client profiles database 520 (step 241). Client profiles may include client demographic information, purchasing history, and other client information. The promoter develops and maintains destination information and vendor profiles in the trip/destination information database 530 and the vendor profile database 540 respectively (step 242). Matching rules are developed and maintained in the matching rules database 560 (step 243). The airline system (402 or 452) is updated with the profiles and rules (step 244). The promoter awaits notification of a transaction that is associated with the marketing material (step 245). The promoter charges the vendor for the transaction (step 246). Based on the latest transaction, the promoter updates the client profile (step 247). Please note that these activities can be performed in differing order.

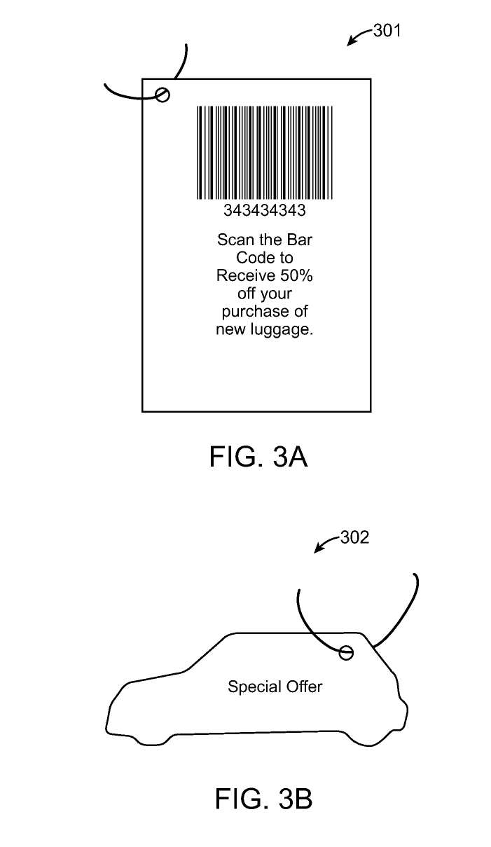

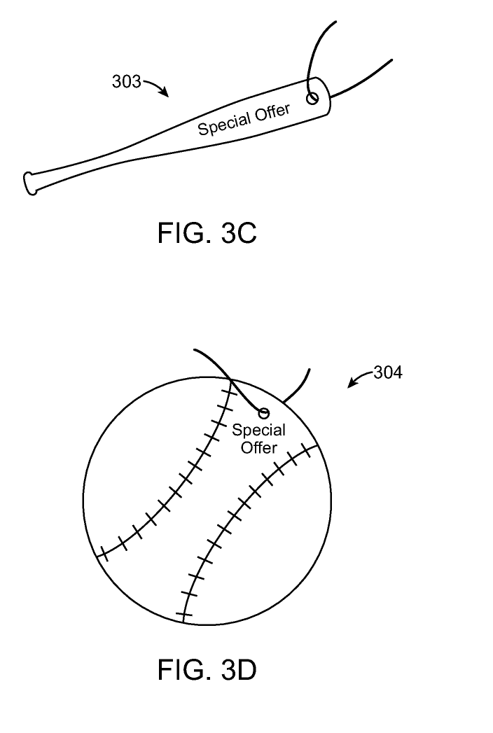

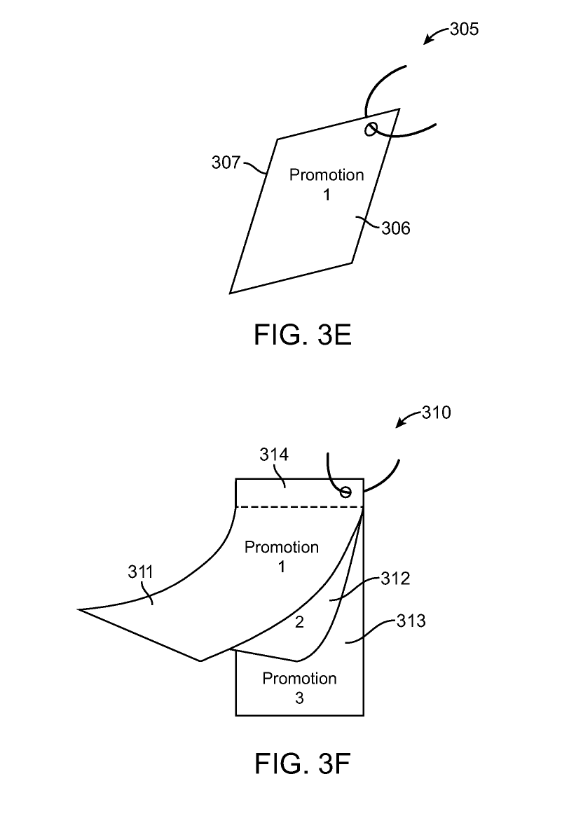

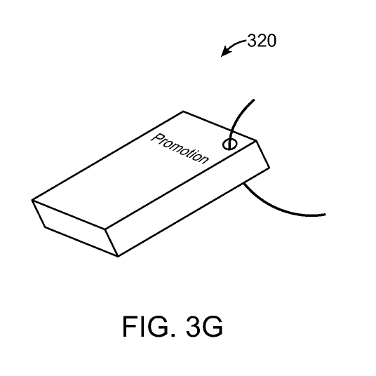

FIGS. 3A-3G are illustrations of exemplary marketing materials. FIG. 3A illustrates a marketing material 301 having a unique number or identifier embedded within a bar code that may be scanned into the airline consumer's mobile phone such as a smart phone to facilitate an online transaction. Employing a unique number or identifier would enable the marketer to track redemption rates for each agent promoting a product. Thus, a promoter could invoice the manufacturer for redemptions as well as identify the agent who attached the marketing material to the baggage for the purposes of paying an incentive.

FIGS. 3B-3D illustrate marketing materials with special offers having the shape of an object. In FIG. 3B, the marketing material 302 is in the shape of a car; in FIG. 3C, the marketing material 303 is in the shape of a baseball bat; and, in FIG. 3D, the marketing material 304 is circular having an imprint to appear as a baseball.

In an embodiment, the special offer may be for a discount or a promotion for a vendor store geographically close to the destination of the airline consumer 140. The special offer may be part of a “deal of the day” business model in which a third party collects personal information from willing consumers and provides offers based on the personal information. In an embodiment, an airline consumer retrieves the baggage 110 with the marketing material 130 and employs a smart phone having the “deal of the day” software application to the scan marketing material 130 to lock in a discount or offer to the airline consumer 140. However, the deal does not necessarily need to be limited for only one day, especially since travelers might not have time to visit the vendor immediately. Instead, the deal may be kept active and valid for an extended time, such as a week or month, depending upon conditions set by the vendor. The airline consumer 140 then goes to the vendor store to purchase the item, or obtain the item if already purchased online or via a smartphone, with the discount or offer.

FIG. 3E illustrates a marketing material 305 having a first promotion on one side 306 and a second promotion on the opposing side 307. FIG. 3F illustrates marketing material 310 having three promotions 311, 312, and 313 which are held together at the top 314 of each of the promotions 311-313. FIG. 3G illustrates a marketing material 320 having a three dimensional shape, which is, in this case, a box that may hold a product sample for example.

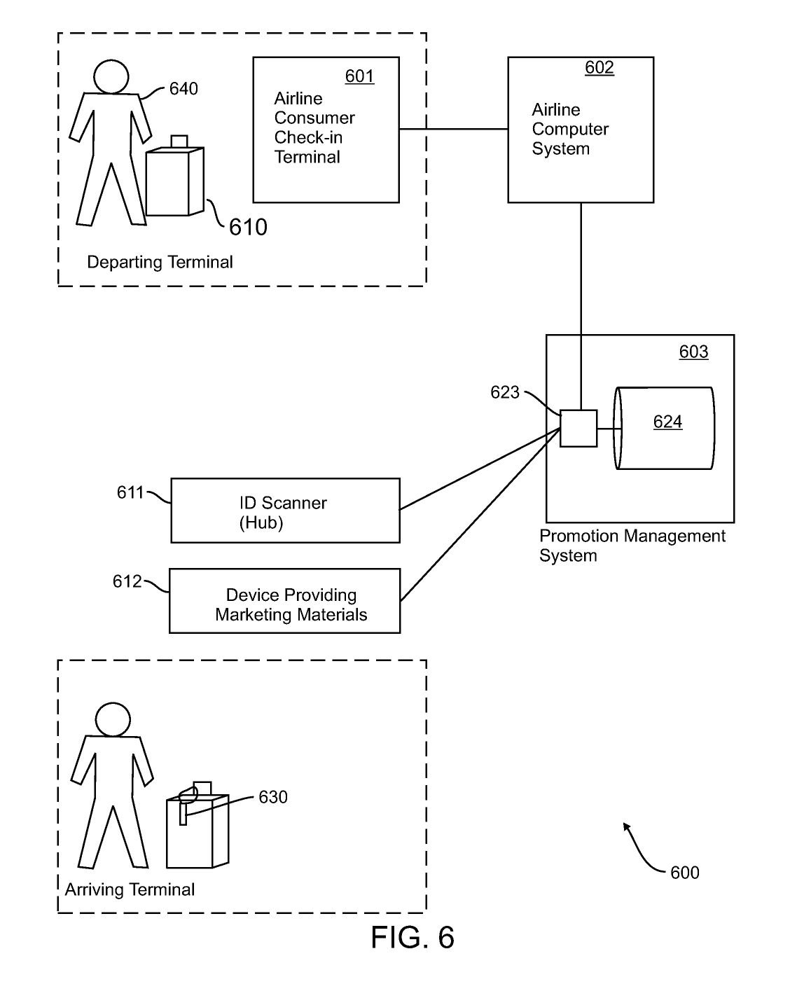

FIG. 6 is a schematic illustration of a preferred system 600 for distributing promotional offers to airline consumers 640 employing a promotion management system 603 coupled to an airline computer system 602. The system 600 has an airline computer system 602 configured for providing routing tag information for an airline consumer's checked baggage 610 and a promoter management system 603 having a database 624 and a processor 623 configured for determining a marketing material 630 based on the routing tag information. The system 600 also has a device for providing marketing materials 612 such that the marketing material is configured for attaching to the checked baggage 610. This device providing marketing materials may be a printer or a “ticket-dispenser” apparatus that provides pre-printed coupons or promotional materials for example. In applications in which the marketing material 630 is attached at an airline's hub airport, a scanner 611 is employed to identify the checked baggage 610 so that the airline computer system 602 can provide routing tag information to the processor 623.

The routing tag information may have one or more of the following data: name of the airport of the airline consumer's destination, the departure time, the airport code of the destination airport, and/or the identity of the airline consumer.

The database 624 preferably has a client profiles database for storing information about the airline consumer. The processor 623 preferably selects marketing materials 630 based on the identity of the airline consumer and a client profile associated with the airline consumer.

The database 624 preferably has a destination information database for storing information on the airline destinations. The marketing material 630 is determined by selecting a marketing material based on the destination of the airline consumer and the destination information database.

The database 624 preferably has a vendor promotions database such that the marketing material 630 is selected by selecting the marketing material based on the identity of the airline consumer, the client profile associated with the airline consumer, the client profiles database, and the vendor promotions database. The device providing the marketing material 612 is preferably located at an airline's hub airport.

The database 624 preferably holds one or more of the following non-limiting types of databases: a client profile database for storing airline consumer's profiles, demographic, purchasing history; a destination database for storing information about the airline's destinations including weather forecasts, current event, local attractions, theme parks, and recreational facilities; a vendor profiles database for storing information on vendors that have associated with the airline or promoter; a vendor promotions database for storing information on current vendor promotions and their respective target market; and matching rules database for determining how the processor 623 selects a marketing material 610 based on the content of one or more of the databases stored in database 624. The market material 630 is preferably selected based on one or more of the following non-limiting characteristics: airline consumer's profile, demographics, purchasing history, whether the airline consumer is traveling alone or with others on the same reservation, the time, the date, and/or destination.

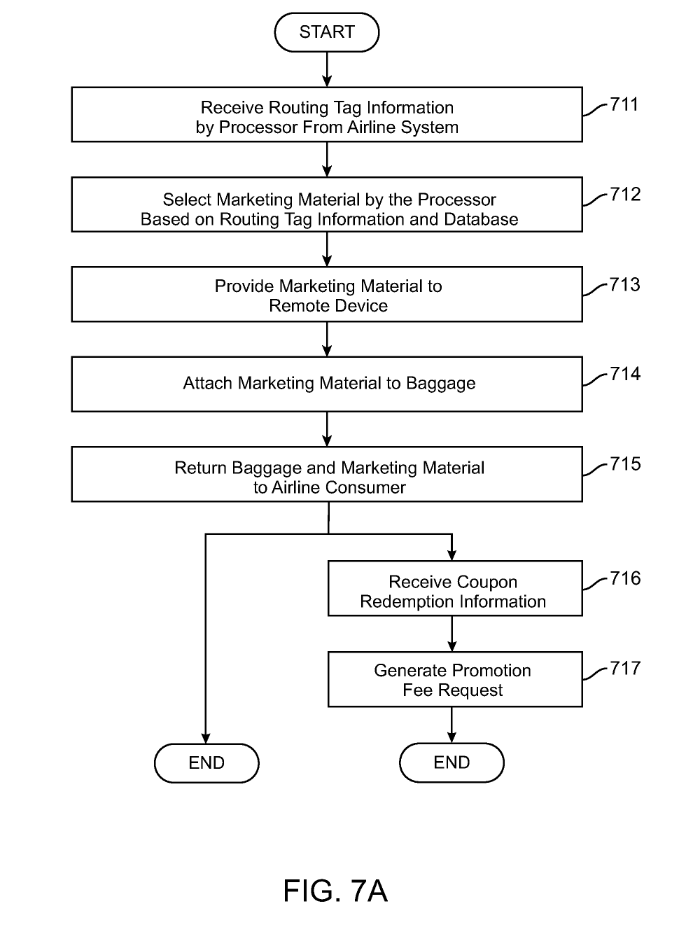

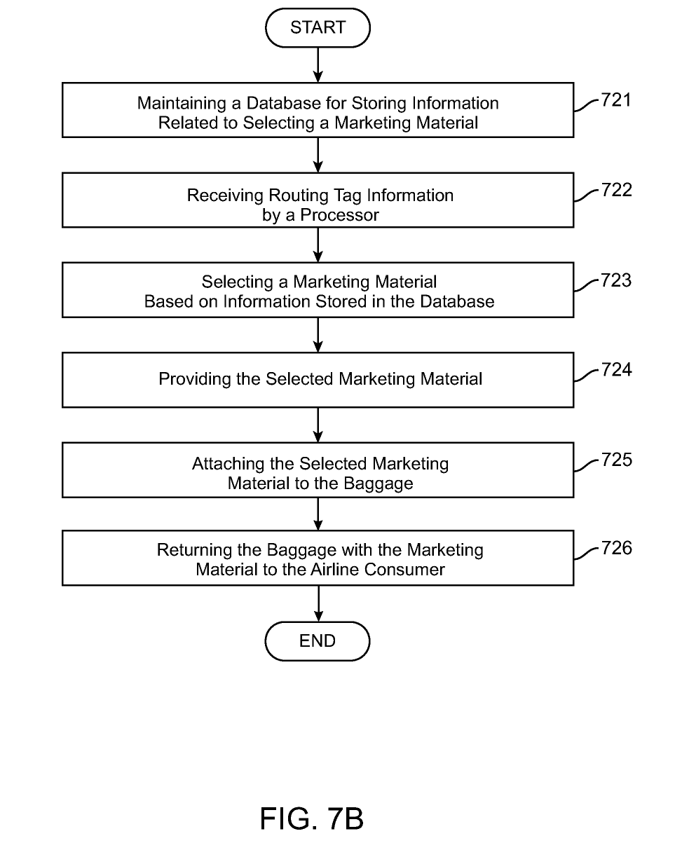

FIG. 7A is a flow chart illustrating an exemplary process for distributing marketing material to airline consumers. Routing tag information is received by a processor 623 from an airline computer system 602 (step 711). The routing tag information is associated with the airline consumer's checked baggage 610. The marketing material is selected by the processor 623 based on the routing tag information (step 712). The selected marketing material 630 is provided from a device in communication with the processor 623 (step 713). The marketing material 630 is configured for attaching to the baggage. The selected marketing material 630 is attached to the baggage 610 either by automated equipment or by airline personnel (step 714). The marketing material may be attached during check-in, during handling, at an airline's hub airport, or at the airline's destination airport. The checked baggage 610 with attached marketing material 630 is returned to the airline consumer 640 (step 715).

The marketing material 630 preferably has a coupon for a company's product or service. The coupon preferably has a unique offer code. Coupon redemption information is received by the processor indicating that the airline consumer has redeemed the coupon (step 716). A promotional fee request is generated from a promoter to a vendor is associated with the redeemed coupon (step 717).

The marketing material is preferably selected based on an arrival time of the airline consumer's flight. The marketing material preferably comprises a discount for new luggage. The marketing material is selected based a profile of the airline consumer which is preferably stored in the database. The marketing material 630 is determined by selecting a marketing material 630 based the weather forecast for the destination at the estimated time of arrival of the airline consumer from a database coupled to the processor for storing airline destination information including forecasted weather. For example, advertisers such as baseball teams may choose to advertise only on days having fair weather.

FIG. 7B is a flow chart illustrating a preferable process for distributing marketing material to airline consumers. The process comprises maintaining a database 624 in communication with a processor 623. The database 624 stores information related to selecting a marketing material (step 721). Routing tag information is received by a processor 623 from an airline computer system 602 where the routing tag information is associated with the airline consumer's checked baggage 610 (step 722). The marketing material 630 is selected based on the routing tag information and the information stored in the database 624 (step 723). Marketing material 630 is provided from a device 612 in communication with the processor 623 (step 724). The marketing material is configured for attaching to the checked baggage 610. The marketing material is attached to the baggage 610 either by an automated process or by airline personnel (step 725). The marketing material 630 may be attached to baggage 610 during check-in, during transit, at an airline's hub airport, or at the destination airport. The baggage 610 and the marketing material 630 are returned to the airline consumer (step 726).

The market material 630 is preferably selected based on one or more of the following non-limiting characteristics: airline consumer's profile, demographics, purchasing history, whether the airline consumer is traveling alone or with others, the time, the date, and/or destination.

The process preferably selects marketing material based on the identity of the airline consumer and the client profile associated with the airline consumer. The process preferably selects the marketing material further comprises selecting a marketing material based on the destination of the airline consumer and the destination information database.

Although the invention has been discussed with reference to specific embodiments, it is apparent and should be understood that the concept can be otherwise embodied to achieve the advantages discussed. The preferred embodiments above have been described primarily as systems and methods for distributing marketing materials via baggage tagging to airline consumers is disclosed. In this regard, the foregoing description of the system and methods is present for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A computer-implemented method of distributing promotional offers to airline consumers, the method comprising:
receiving routing tag information by a processor from an airline computer system, wherein the routing tag information is associated with an airline consumer's checked baggage;
selecting a marketing material by the processor based on the routing tag information;
providing the selected marketing material from a device in communication with the processor, wherein the marketing material is configured for attaching to the baggage;
attaching the marketing material to the baggage; and
returning the baggage with attached marketing material to an airline consumer.

2. The computer-implemented method of claim 1, wherein the marketing material comprises a discount for new luggage.

3. The computer-implemented method of claim 1, wherein the marketing material comprises a coupon for a company's product or service.

4. The computer-implemented method of claim 3, wherein the coupon further comprises a unique offer code.

5. The computer-implemented method of claim 4, further comprising receiving coupon redemption information by the processor indicating that the airline consumer has redeemed the coupon.

6. The computer-implemented method of claim 5, further comprising generating a promotional fee request from a promoter to a vendor associated with the redeemed coupon.

7. The computer-implemented method of 1, wherein selecting the marketing material further comprises selecting the marketing material based on an arrival time of the airline consumer's flight.

8. The computer-implemented method of 1, wherein selecting the marketing material further comprises selecting a marketing material based a profile of the airline consumer.

9. The computer-implemented method of 1, wherein selecting the marketing material further comprises selecting a marketing material based on a weather forecast for the destination at the estimated time of arrival of the airline consumer.

10. A computer-implemented method of distributing promotional offers to airline consumers, the method comprising:
maintaining a database in communication with a processor for storing information related to selecting a marketing material;
receiving routing tag information by the processor from an airline computer system, wherein the routing tag information is associated with an airline consumer's checked baggage;
selecting a marketing material by the processor based on the routing tag information and the information stored in the database;
providing the selected marketing material from a device in communication with the processor, wherein the marketing material is configured for attaching to the baggage;
attaching the marketing material to the baggage; and
returning the baggage and the attached marketing material to the airline consumer.

11. The computer-implemented method of claim 10, wherein:
the routing tag information further comprises an identity of an airline consumer and a destination of the airline consumer;
the database further comprises a client profiles database for storing a client profile associated with the airline consumer; and
selecting the marketing material further comprises selecting a marketing material based on the identity of the airline consumer and the client profile associated with the airline consumer.

12. The computer-implemented method of claim 11, wherein:
the database further comprises a destination information database for storing information on airline destinations; and
selecting the marketing material further comprises selecting a marketing material based on the destination of the airline consumer and the destination information database.

13. The computer-implemented method of claim 11, wherein:
the database further comprises a vendor promotions database; and
selecting the marketing material further comprises selecting a marketing material based on the identity of the airline consumer, the client profile associated with the airline consumer, the client profiles database, and the vendor promotions database.

14. The computer-implemented method of claim 10, wherein the device providing the marketing material is located at an airline consumer's departing airport.

15. The computer-implemented method of claim 10, wherein the device providing the marketing material is located at an airline's hub airport.

16. The computer-implemented method of claim 10, wherein the device providing the marketing material is located at an airline's destination airport.

17. A system for distributing promotional offers to airline consumers, the system comprising:
an airline computer system configured for providing a routing tag information for an airline consumer's checked baggage;
a promotion management system having a database coupled to a processor configured for selecting a marketing material based on the routing tag information; and
a device for providing a marketing material wherein the marketing material is configured for attaching to the checked baggage.

18. The system of claim 17, wherein:
the routing tag information further comprises an identity of an airline consumer and a destination of the airline consumer;
the database further comprises a client profiles database for storing information about the airline consumer; and
the processor is further configured for selecting marketing material based on the identity of the airline consumer and a client profile associated with the airline consumer.

19. The system of claim 18, wherein:
the database further comprises a destination information database for storing information on the airline destinations; and
the processor is further configured for selecting the marketing material based on the destination of the airline consumer and the destination information database.

20. The system of claim 18, wherein:
the database further comprises a vendor promotions database; and
the processor is further configured for selecting the marketing material based on the identity of the airline consumer, the client profile associated with the airline consumer, the client profiles database, and the vendor promotions database.

21. The system of claim 17, wherein the device providing the marketing material is located at an airline's hub airport.

22. The system of claim 17, wherein the marketing material comprises a deal with an extended timeline for redeeming.
